(19) United States
(12) Patent Application Publication
(10) Pub. No.: US 2009/0260705 A1
(43) Pub. Date: Oct. 22, 2009

(54) Concrete pump discharge hose safety device

(76) Inventor: Leslie Ernest Ainsworth, Denver, CO (US)

Correspondence Address: Leslie E Ainsworth, 6560 Vine Ct, Denver, CO, 80229, US

(21) Appl. No.: 12/148,408

(22) Filed: Apr. 18, 2008

(51) Int. Cl. F16L 3/10

(52) U.S. Cl. 138/110; 138/161; 138/167

(57) ABSTRACT

A concrete hose safety device has two stiff elongated hemi-cylindrical sections which may be half tubes or less than half, the sections having internal diameters roughly equal to the external diameter of a concrete hose. A plurality of hinge straps secure the sections in parallel and allowing them to open to allow a concrete hose to be laid therein and closed with the concrete hose secured therein. A plurality of closure straps then hold the device closed. In use, an operator may simply rely on-the device to prevent the concrete hose from whipping due to air in the hose, surge and so on.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to concrete pouring devices, and specifically to safety devices for concrete pump discharge hoses.

### STATEMENT REGARDING FEDERALLY FUNDED RESEARCH

This invention was not made under contract with an agency of the US Government, nor by any agency of the US Government.

### BACKGROUND OF THE INVENTION

Concrete pumps used for the pouring of concrete into forms, slabs and so on offer a great convenience to workers as the discharge hose allows concrete to be poured accurately into even small areas not accessible from a concrete truck. This pouring can occur without the use of shovels, wheelbarrows or other devices required in the past. Since boom trucks can extend their booms for large distances, the flexibility of the approach is quite wide. Concrete pumps use hydraulic pressure to force the wet concrete through the hose and pipe to the point of placement.

However, concrete hoses can present a danger to the workers using them, particularly in the event of air getting into the hose. While concrete boom operators are trained to prevent hose whipping, there nonetheless remains the strong possibility that a concrete hose or boom will exhibit various dangerous behaviors caused when air is introduced into the line or a blockage occurs.

None of these problems, including air getting into the hose line, is completely solvable.

While there are no safety devices to prevent the whipping of the discharge hose when air is expelled, there are several procedures used to attempt to prevent it from occurring. The discharge of air under pressure can have a deadly effect on the man operating the tip end of the concrete hose, and on those near by to the place where the hose dangles from the end of the boom.

Concrete is extremely heavy: while it is wet and fluid, it is not light, and it has substantial mass and even momentum inside the pipe and hose. When air in the pipe is compressed it causes the concrete or the hose to move wildly and unpredictably, an eruption of heavy concrete can come from the end of the hose, and the force inside the hose may whip it around wildly, despite its great weight.

This is a non-trivial danger: construction workers occasionally die from this.

It would be preferable to provide a method by which the construction worker holding the hose tip could protect himself from flow irregularities and whipping hoses regardless of the use of other safety devices and regardless of the source of flow irregularities.

### SUMMARY OF THE INVENTION

General Summary

The present invention is a concrete hose safety device which a hose operator may use on any concrete discharge hose without any equipment on the truck, pump, boom or the like, and which will operate to protect the hose operator regardless of the nature of the disruption in the line, air in the hose being the primary danger which could otherwise cause the hose to whip and injure the operator.

The device of the invention has two stiff elongated hemi-cylindrical (trough-like) sections: these may be 180 degree half tubes or may in embodiments be slightly less than half of the radius of a cylinder. The material of the sections may be any stiff, strong, light material, including polyvinylcarbonate (PVC) fiberglass, composites, polymers, metals and so on.

The sections have internal diameters which roughly equal the external diameter of a standard size concrete hose. Various standard sizes exist: 3″, 4″, 5″ in different matching sizes the invention may be used with most or all hose sizes.

A plurality of hinge straps secure the two sections in parallel, face to face, thus allowing them to enclose a section of concrete hose: since the internal diameter of the device matches the external diameter of the hoses with which it is used, the hose will be tightly contained by the device for the length of the device. The hinge straps also open to allow the concrete hose to be removed or laid therein. A plurality of closure straps hold the device closed in cooperation with fasteners such as buckles, tie-downs or the like.

In operation, an operator simply secures the device over a section of hose near the end and then relies upon the device to prevent the concrete hose from whipping due to air in the hose, surge or blockages. If re-adjustment of the device to a new portion of the hose is necessary, the operator may make such a change very quickly and easily.

### SUMMARY IN REFERENCE TO CLAIMS

It is therefore another aspect, advantage, objective and embodiment of the invention, in addition to those discussed previously, to provide a concrete hose safety device for use with a concrete hose having an external diameter, the concrete hose safety device comprising:
first and second hemi-cylindrical sections, each having a concave internal diameter substantially equal to such external diameter of such concrete hose;
a plurality of hinge members securing the first and second hemi-cylindrical sections in parallel and allowing the first and second hemi-cylindrical sections to assume a first open position in which the first and second hemi-cylindrical sections are parallel with the internal diameters facing a first direction and also able to assume a second closed position in which the first and second hemi-cylindrical sections are parallel with the concave internal diameters facing one another; and
a plurality of closure members operative to maintain the first and second hemi-cylindrical sections in the second closed position.

It is therefore another aspect, advantage, objective and embodiment of the invention to provide a concrete hose safety device wherein the hinge members further comprise:
a plurality of flexible straps, each strap having first and second ends secured to the respective first and second hemi-cylindrical sections.

It is therefore another aspect, advantage, objective and embodiment of the invention to provide a concrete hose safety device wherein the closure members further comprise:
a plurality of flexible straps, each strap having first and second ends, the first end secured to the first hemi-cylindrical section and the second end able to operatively engage a fastener secured to the second hemi-cylindrical section.

It is therefore another aspect, advantage, objective and embodiment of the invention to provide a concrete hose safety device wherein the fastener further comprises a buckle.

It is therefore another aspect, advantage, objective and embodiment of the invention to provide a concrete hose safety device further comprising a length of the first and second hemi-cylindrical sections, wherein the length is at least 6 feet.

It is therefore another aspect, advantage, objective and embodiment of the invention to provide a concrete hose safety device wherein the internal diameter is one member selected from the group consisting of: 3 inches, 4 inches, 5 inches, and combinations thereof.

It is therefore another aspect, advantage, objective and embodiment of the invention to provide a concrete hose safety device wherein the material of the hemi-cylindrical sections is lightweight and rigid.

It is therefore another aspect, advantage, objective and embodiment of the invention to provide a concrete hose safety device wherein the material of the hemi-cylindrical sections is one member selected from the group consisting of: metal, high strength polymer, composites, and combinations thereof.

It is therefore another aspect, advantage, objective and embodiment of the invention to provide a concrete hose safety device further comprising:
a flexible handle secured to the flexible straps.

### BRIEF DESCRIPTION OF THE DRAWINGS

FIG. 1 is an orthogonal elevational view of the first embodiment of the device in the open position.

FIG. 2 is an orthogonal elevational fastener-side view of the first embodiment of the device in the closed position.

FIG. 3 is an orthogonal elevational hinge-side view of an alternative embodiment of the device in the closed position.

FIG. 4 is an orthogonal elevational view of the first embodiment of the device in use, showing a concrete hose therein: the difference in diameter between the concrete hose and the device is deliberately exaggerated for clarity.

### INDEX TO REFERENCE NUMERALS

Hemi-tubular body section 102
Hemi-tubular body section 104
First open end 106
Second open end 108
Closure strap 110
Closure strap 112
Closure strap 114
Strap handle 116
Fastener 120
Fastener 124
Fastener 126
Hinge strap 130
Hinge strap 132
Hinge strap 134
Concrete hose 202
Concrete hose projecting portion 204
Concrete hose end 206 A.

### DETAILED DESCRIPTION

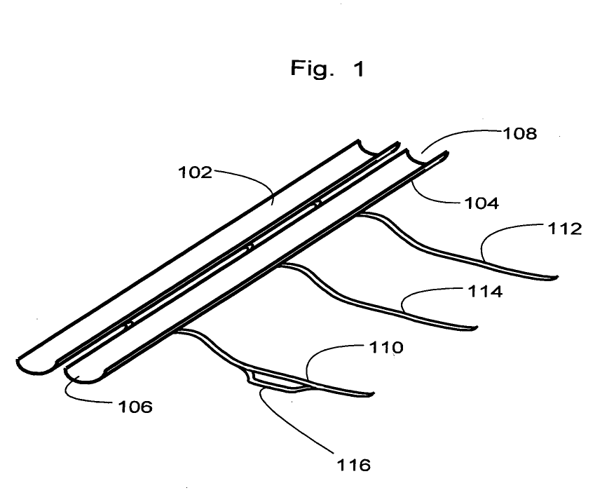

FIG. 1 is an orthogonal elevational view of the first embodiment of the device in the open position. Half-tubular body sections 102 and 104 may be exactly half a tube (180 degrees) or may be slightly less and yet still maintain the concrete hose secured within the space between them when they are face to face. The term “hemi-cylindrical” is used herein to indicate that the sections may be 180 degrees of radius each or may cover different degrees of arc: 160 degrees each, or one 120 degrees and the other 200 degrees, and so on. So long as the two sections total enough to keep the hose stiff (possibly considerably less than 360 total degrees in alternatives), the sections may be considered “hemi-cylindrical” and to fall within the invention as defined herein.

A flexible strap handle 116 may be secured to one of the straps, such as strap 110. Additional handles may be used as well.

First open end 106 and second open end 108 allow a hose to pass across either of the sections when open: the fit of the device may in embodiments be so tight that inserting the hose from end to end is not possible, in fact, this is be preferable.

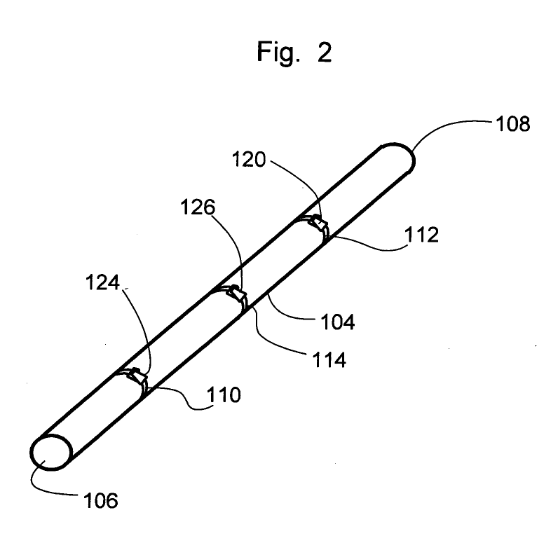

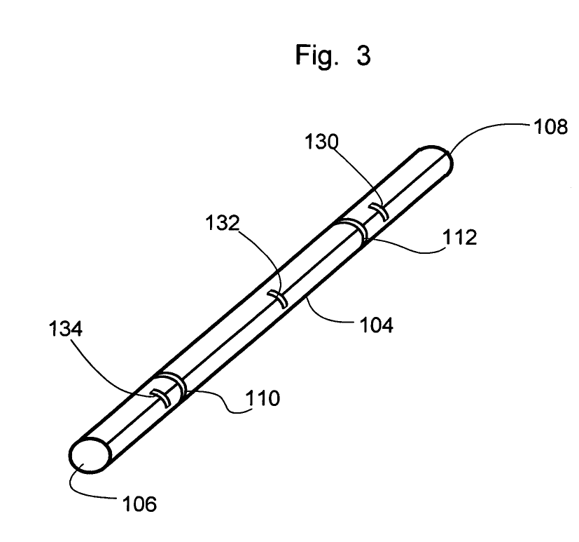

Closure straps 110, 112 and 114 may be used to secure the device closed, as shown in FIG. 2, which is an orthogonal elevational fastener-side view of the first embodiment of the device in the closed position. Straps 110 and 112 have been wrapped around both sections, and fasteners 120, 124 and 126 then prevent the straps from moving, thus holding the device closed securely closed. Fasteners 120, 124 and 126 may be buckles, which are strong, but other fasteners which demonstrate the strength to hold the device closed during whipping may also be used. FIG. 3 is an orthogonal elevational hinge-side view of an alternative embodiment of the device in the closed position. Hinge straps 130, 132, and 134 may be seen securing the two sections together. This alternative embodiments demonstrates that different numbers of straps may be used and other minor changes may be made without departing from the scope of the invention. Other hinges may be used: metal hinges, flexible sections or the like. However, under the rugged, concrete-laden construction site conditions of use, metal hinges are less preferable than hinge straps which long enough to allow the sections to open and close yet holding the sections together closely enough to prevent a hose pipe from escaping.

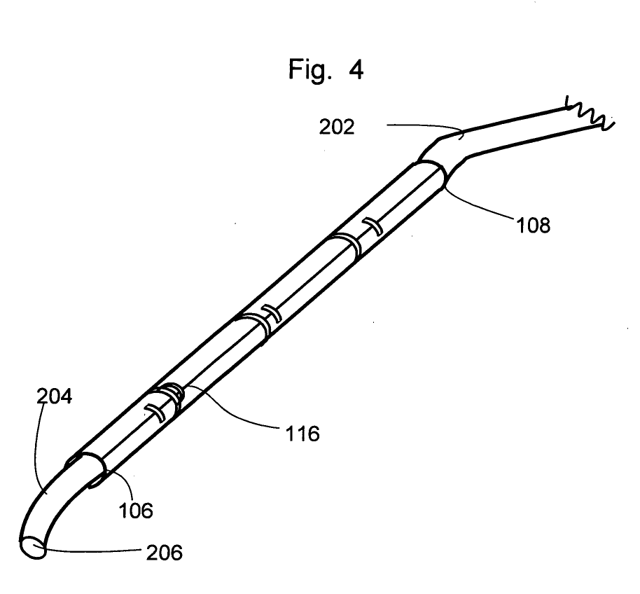

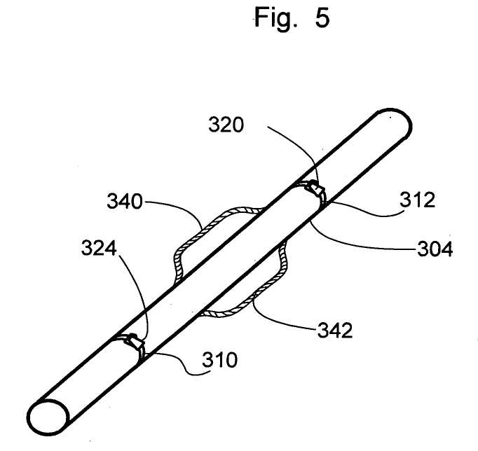

FIG. 4 is an orthogonal elevational view of the first embodiment of the device in use, showing a concrete hose 202 therein: the difference in diameter between the concrete hose 202 and the device is deliberately exaggerated for clarity. In actual practice, the diameters are preferably the same, causing the entire length of the sections internal diameters to press against the hose 202 in a frictional engagement. Concrete hose 202 has a projecting portion 204 having the discharging hose end 206 thereat, by which means the concrete wet-mix may easily escape the hose in the normal manner.

The length of the projecting portion 204 may be anything from zero up to a large distance, however, the point of the device is safety, and so a projecting portion length of 12 to 24 inches has been established to be optimal to allow the end of the hose to flex a bit for operator convenience but to prevent the overall length of the end of the hose 262 from being able to whip due to air in the hose. The device may have indicia indicating the safe parameters of use.

Note that hand grips may not be necessary under normal circumstances of use, as the typical concrete hose diameter (a few inches) is itself a convenient hand-hold. However, hand grips may aid in holding the device under adverse conditions, or when it is not fastened closed and thus may swing around the hinges a bit, or for handling and the like. Hand grips may be flexible as shown (for example sections of webbing, rope or cable) or may be stiff projections or the like.

In the presently preferred embodiment and best mode presently contemplated for carrying out the invention, hand straps are used, for the sake of simplicity and to avoid allowing hard handles or grips to catch on concrete forms or the like.

Straps as defined herein include nylon webbing, other fabric webbing, leather straps, metal straps and the like.

In use, a concrete worker who would ordinarily grasp the end of the concrete hose without any stiffening will instead open the device, put the semi-cylindrical sections about the hose, and then close it with the closure straps, fastening the straps in place with the fastener buckles. This in turn allows the user to begin pumping operations without fear that the section of hose secured snugly within the invention will be able to whip and injure him. Note that the worker may either grasp the device itself (and embodiments may have handles to assist with maintaining that grip) or may grip the hose normally, particularly the free end of projecting hose portion 204. Flexibility in the hose is important in allowing the worker to place the wet concrete mix accurately, especially given the obstructions present all: forms, other pieces of construction, pre-existing structure if any, construction equipment and so on. Since the invention may employed at whatever section of the hose the worker finds most effective and most safe, the invention will not significantly hinder the construction worker in getting about such obstructions and still pouring the concrete accurately. In the event that additional flexible hose projection 204 is needed, or if the worker decides that too much is projecting, the worker can signal the boom/pump man for a brief halt, adjust the placement of the device on the hose in less than a minute, and be back to work almost instantly.

In the event of surge, vibration or whipping for any reason, the invention will immediately act to dampen the whip (by forcing a large section of the hose to remain stiff and move as a unit) and will in addition offer the worker an effective handhold for controlling the hose: a solid grip on any portion of the invention will assure the worker that no portion of the hose can injure him.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A concrete hose safety device for use with a concrete hose having an external diameter, the concrete hose safety device comprising:
first and second hemi-cylindrical sections, each having a concave internal diameter substantially equal to such external diameter of such concrete hose;
a plurality of hinge members securing the first and second hemi-cylindrical sections in parallel and allowing the first and second hemi-cylindrical sections to assume a first open position in which the first and second hemi-cylindrical sections are parallel with the internal diameters facing a first direction and also able to assume a second closed position in which the first and second hemi-cylindrical sections are parallel with the concave internal diameters facing one another; and
a plurality of closure members operative to maintain the first and second hemi-cylindrical sections in the second closed position.

2. The concrete hose safety device of claim 1, wherein the hinge members further comprise:
a plurality of flexible straps, each strap having first and second ends secured to the respective first and second hemi-cylindrical sections.

3. The concrete hose safety device of claim 1, wherein the closure members further comprise:
a plurality of flexible straps, each strap having first and second ends, the first end secured to the first hemi-cylindrical section and the second end able to operatively engage a fastener secured to the second hemi-cylindrical section.

4. The concrete hose safety device of claim 3, wherein the fastener further comprises a buckle;.

5. The concrete hose safety device of claim 1, further comprising a length of the first and second hemi-cylindrical sections, wherein the length is at least 6 feet.

6. The concrete hose safety device of claim 1, wherein the internal diameter is one member selected from the group consisting of: 3 inches, 4 inches, 5 inches, and combinations thereof.

8. The concrete hose safety device of claim 1, wherein the material of the hemi-cylindrical sections is polyvinylcarbonate, PVC.

9. The concrete hose safety device of claim 1, wherein the material of the hemi-cylindrical sections is one member selected from the group consisting of: metal, high strength polymer, composites, and combinations thereof.

9. The concrete hose safety device of claim 3, further comprising:
a flexible handle secured to one flexible strap.
